(19) United States
(12) Patent Application Publication
(10) Pub. No.: US 2017/0339985 A1
(43) Pub. Date: Nov. 30, 2017

(54) COFFEE AROMA COMPOSITION

(71) Applicant: NESTEC S.A., Vevey (CH)

(72) Inventors: Xiaoping Fu, Dublin, OH (US); Carol Borland, Richwood, OH (US)

(73) Assignee: NESTEC S.A., Vevey (CH)

(21) Appl. No.: 15/537,195

(22) PCT Filed: Aug. 27, 2015
(86) PCT No.: PCT/EP2015/069696

§ 371 Date: Jun. 16, 2017

Related U.S. Application Data
(60) Provisional application No. 62/094,196, filed on Dec. 19, 2014.

(51) Int. Cl. A23L 2/56; A23F 5/48; A23L 27/28

(52) U.S. Cl. CPC A23L 2/56; A23L 27/28; A23F 5/486

(57) ABSTRACT

The present invention relates to a coffee aroma composition comprising milk fat useful for addition to a food or beverage product, e.g. a coffee beverage, a method of producing a coffee aroma composition and a method of producing a liquid coffee beverage.

### FIELD OF THE INVENTION

The present invention relates a coffee aroma composition, a method of producing a coffee aroma composition and a method of producing a coffee beverage composition.

### BACKGROUND

Liquid coffee beverages sold ready for consumption, sometimes called RTD (ready to drink) coffee beverages are popular and a convenient way to enjoy coffee. These beverages are often enjoyed cold and often include milk and/or sweeteners. In these situations the experience by the consumer of the coffee aroma is limited as compared to a traditional hot cup of coffee, due to the lower temperature and/or the presence of milk and other ingredients which may inhibit the release of coffee aroma compounds. There is therefore a desire to increase the experience of coffee aroma during consumption and also the experience of coffee aroma release when opening of the container, preferably with the use of natural coffee aroma compounds.

During the production of soluble coffee powders, which are obtained from commercial processes involving extraction, concentration, and drying, it is conventional to recover coffee aromas from the roast and ground coffee and to reincorporate these aromas, e.g. into concentrated coffee extract prior to drying into a soluble coffee powder. In this way the aroma perception of the powdered soluble coffee can be increased, as aromas would otherwise be lost during process steps such as extraction and concentration. The coffee aromas may be recovered at several points during processing, e.g. by aroma stripping of roast and ground coffee prior to extraction. WO 01/13735 discloses a method of recovering coffee aroma from coffee grounds comprising wetting, heating and stripping aroma from coffee grounds exposing the coffee grounds to a decreased pressure. The coffee aroma compounds released by this treatment are then recovered. EP 1069830 discloses a method comprising providing a slurry of roast and ground coffee and stripping aroma from this slurry by using a gas to provide an aromatised gas. In both methods aroma compounds are released from roast and ground coffee into a gas phase from where it is collected. The purpose of these methods is to achieve the most effective capture of all aroma compounds and to reincorporate them in the final product to ensure a complete and balanced coffee aroma. Such methods have not been extensively applied to coffee beverages that are distributed and sold as liquid beverages ready to be consumed, and they have generally been found to be ineffective to deliver the desired aroma release from a cold liquid coffee beverage, especially if the beverage further comprises milk ingredients and/or other additional ingredients. The object of the present invention is to provide an aroma composition which has an improved capture, stabilisation and/or release of coffee aroma useful for addition to other food and beverages products, e.g. liquid coffee beverages, and useful to improve the aroma release and aroma experience by the consumer, e.g. when opening and consuming a liquid coffee beverage, even at low temperature.

### SUMMARY OF THE INVENTION

The inventors have found that an aroma composition comprising milk fat and coffee aroma has an improved retention and stability of coffee aroma. The ingredient is useful for storing coffee aroma and for addition of coffee aroma to food and beverages products, particularly products wherein milk components are desired, e.g. liquid coffee beverages comprising milk. Accordingly, the present invention relates to a coffee aroma composition comprising milk fat and coffee aroma compounds derived from roast coffee beans in an amount of at least 1 g per gram of milk fat. In further aspects the invention relates to a method of producing a coffee aroma composition and methods of producing liquid coffee beverages.

### DETAILED DESCRIPTION OF THE INVENTION

The present invention relates to a coffee aroma composition comprising milk fat and coffee aroma compounds derived from roast coffee beans. A coffee aroma compound may be any compound derived from roast coffee beans which contributes to the aroma of coffee. Coffee aroma compounds according to the invention are preferably coffee aroma compounds with high volatility that can be derived from roast coffee beans during soluble coffee processing (e.g. grinding, pre-wetting, and extraction) by stripping of roast and ground coffee beans with steam or by cryogenic condensation of aroma gases. The typical aroma of coffee is comprised of a large amount of chemical compounds contributing different notes and characteristics of the aroma. The volatility of these compounds varies, and they may be divided into classes depending on the volatility. Examples of high volatile coffee aroma compounds are methanethiol, dimethylsulfide, dimethyldisulfide, methylpropanal, 2-methylbutanal, 3-methylbutanal, 2-methyl-furan, and N-methyl-pyrrole; examples of low volatile coffee aroma compounds are 2-ethyl-5-methylpyrazine, 2-ethyl-6-methylpyrazine, trimethylpyrazine, 2-ethyl-3,5-dimethylpyrazine, 2-ethyl-3,6-dimethylpyrazine, 2,3-diethyl-5-methylpyrazine, pyridine, furfural, furfurylalcohol, 5-methylfurfural, guaiacol, ethylguaiacol, vinylguaiacol, and acetic acid. All these compounds have been identified as part of coffee aroma.

A coffee aroma composition of the invention comprises at least 1 g of coffee aroma compounds per gram of milk fat, preferably at least 3 g, more preferably at least 5 g of coffee aroma compounds per gram of milk fat. The coffee aroma composition of the invention comprises milk fat. The amount of milk fat in the composition may vary, e.g. depending on the intended use of the aroma composition. In a preferred embodiment, the composition comprises between 0.5% (by weight) and 36%, more preferably between 1% and 30%, and even more preferably between 2% and 20% of milk fat (by weight). The aroma composition is preferably in the form of an aqueous emulsion of milk fat. In a preferred embodiment the coffee aroma composition comprises milk such as e.g. partially skimmed milk, whole milk, cream and/or concentrated milk.

The coffee aroma composition of the invention preferably comprises less than 10 mg of galactomannans and arabinogalactans per gram of dry matter. In a further preferred embodiment the coffee aroma composition does not contain galactomannans and arabinogalactans. Galactomannans and arabinogalactans are carbohydrates found in coffee beans and extracted when coffee beans are extracted with water. Coffee beverages comprising coffee extract thus comprise galactomannans and arabinogalactans. A normal brew of coffee roast and ground coffee comprise 15-25% of galactomannans and arabinogalactans in dry matter. Galactomannans and arabinogalactans do not contribute to the aroma of coffee and are therefore not considered to be coffee aroma compounds. The coffee aroma composition of the present invention comprises aroma compounds of coffee but no or only minor amounts of galactomannans and arabinogalactans.

The present invention also relates to a method of producing the coffee aroma composition of the invention, the method comprising the following steps: a) Collecting aroma gas from grinding, prewetting and extraction to; b) recovering aroma compounds by a cryogenic condensation to form an aroma frost; c) adding recovered aroma frost of step b to a liquid composition comprising milk fat to produce a coffee aroma composition comprising coffee aroma and milk fat. Also the coffee aroma composition of the invention could be produced by the following steps: a) stripping coffee aroma from roast and ground coffee with steam to produce steam comprising coffee aroma; b) recovering aroma compounds from steam comprising coffee aroma; c) adding recovered aroma compounds of step b to a liquid composition comprising milk fat to produce a coffee aroma composition comprising coffee aroma and milk fat.

Any suitable method of stripping coffee aroma from roast and ground coffee with steam may be used in the method of the invention. Several methods for stripping roast and ground coffee are known in the art e.g. from WO 01/13735 where aroma gas is released from roast and ground coffee under decreased pressure and EP 1069830 wherein a gas stream is used for stripping aroma into the gas phase. The stripping step produces steam comprising volatile coffee aroma compounds. The volatile coffee aroma compounds may be recovered from the steam by any suitable method, e.g. by compression of the steam in the presence of an aqueous liquid whereby the high volatile aromas as transferred to the aqueous liquid, e.g. as disclosed in WO 2011/076564. The liquid is preferably water, more preferably deoxygenated water. Preferably, the compression is performed at a pressure between 1 and 20 bar absolute pressure, such as between 2 and 15 bar absolute pressure, or between 2 and 8 bar absolute pressure. The pressurisation is performed in the presence of an aqueous liquid. By this is meant that the gas phase is in contact with an aqueous liquid during the pressurisation. The aroma may also be recovered by condensation, e.g. by cryo-condensation, e.g. as disclosed in EP 0532959. The aroma that has been recovered from the steam or condensation is added to a liquid composition comprising milk fat. The liquid composition comprising milk fat may be any liquid composition comprising milk fat suitable for the intended use of the coffee aroma composition. The liquid composition comprising milk fat may e.g. be milk, such as e.g. partially skimmed milk, whole milk and cream, concentrated milk, or it may be an emulsion of milk fat in any suitable aqueous composition. The aroma may be added to the liquid composition in any suitable way, e.g. the aroma may be added in liquid form into the composition and mixed therewith or, e.g. if the aroma has been recovered by cryo-condensation, it may be added as a frost into the composition and mixed. The aroma is preferably added in an amount of at least 1 g of coffee aroma compounds per gram of milk fat, more preferably at least 3 g, even more preferably at least 5 g of coffee aroma compounds per gram of milk fat.

The invention further relates to a method of producing a liquid coffee beverage, the method comprising adding the coffee aroma composition of the invention, and/or a coffee aroma composition produced by the method of the invention, to a liquid coffee extract. By a liquid coffee beverage is meant any beverage based on coffee or wherein coffee is an ingredient and wherein the perception of coffee aroma upon opening and/or consumption of the beverage is intended. The liquid coffee extract may be any liquid coffee extract suitable for producing a coffee beverage, methods of producing coffee extracts are well known in the art of soluble coffee production, e.g. from EP 0826308 and EP 0916267. The liquid coffee extract may be prepared by dissolution of a dried powdered coffee extract in water.

In a preferred embodiment the liquid coffee beverage comprises between about 0.1% and about 60% (weight/weight) of coffee solids, preferably between about 0.5 and about 50%. In another preferred embodiment the liquid coffee beverage comprises between about 0.1% and about 5% (weight/weight) of coffee solids, preferably between about 0.5 and about 2.5% more preferably between about 0.9% and about 1.6%. By coffee solids is meant any material derived from a coffee plant, preferably from coffee beans. Coffee solids may e.g. be derived from green or roasted coffee beans, preferably from roasted coffee beans. A liquid coffee beverage according to the invention may be a liquid coffee concentrate intended for dilution before consumption. A liquid coffee concentrate may typically comprise between about 10% (weight/weight) and about 60% of coffee solids, accordingly, in a preferred embodiment the liquid coffee beverage comprises between about 10% (weight/weight) and about 60% of coffee solids, preferably between about 20% (weight/weight) and about 50% of coffee solids.

The liquid coffee beverage may be in a closed container with a gaseous headspace. By gaseous headspace is meant a volume of gas inside the container wherein volatile compounds, such as volatile coffee aroma compounds, from the liquid coffee beverage will be present in equilibrium with the liquid. When the container is opened by the consumer the gaseous headspace will diffuse out of the container and into the surrounding air, and volatile coffee aroma compounds present in the headspace can be perceived by the consumer upon opening and/or during consumption of the liquid beverage. The liquid coffee beverage may be in any suitable closed container, such as e.g. containers conventionally used for liquid coffee beverages, such as e.g. aluminium cans, PET bottles, glass bottles, stainless steel and the like.

The amount of high and low volatile coffee aroma compounds in the gaseous headspace can be determined by methods known in the art. A preferred method is the use of Solid Phase Micro Extraction (SPME) of the aroma compounds in the headspace by a fiber coated with Carboxen, Divinylbenzene and Polydimethylsiloxane. Extraction is performed after equilibrating the liquid beverage at 25° C., by contacting the fiber with the gaseous headspace and allowing equilibrium of volatile aroma between the gaseous headspace and the fiber to be reached. Subsequently the volatile aroma compounds are desorbed from the fiber at 250° C. into the inlet port of a gas chromatograph for separation and quantified by mass spectroscopy.

The liquid coffee beverage may comprise further milk solids in addition to the milk fat comprised in the coffee aroma composition. By milk solids is meant any compound or fraction derived from milk, except water, such as e.g. milk protein, e.g. casein, caseinate, whey protein, whey protein isolate, whey protein concentrate; milk fat; lactose; skim milk; whole milk; cream; milk powder, e.g. skim milk powder, whole milk powder, cream powder; butter fat; and combinations thereof. In a preferred embodiment, the liquid coffee beverage of the invention comprises between about 0.5% and about 20% (weight/weight) of milk solids, preferably between about 1% and about 10%, more preferably between about 2% and about 5% of milk solids. In one embodiment all of the milk solids of the liquid beverage composition are added as part of the coffee aroma composition of the invention.

The liquid coffee beverage may comprise fat and/or oil, e.g. milk fat as part of milk solids, and/or vegetable oil such as e.g. coconut oil, soy oil, palm oil, canola oil, corn oil, safflower oil, and/or sunflower oil. In a preferred embodiment the liquid beverage product comprises between about 0.5% and about 8% of fat and/or oil.

The liquid coffee beverage may further comprise one or more sweeteners, e.g. in the form of sugars. The liquid coffee beverage may e.g. comprise one or more sugars selected from the group consisting of lactose, sucrose, fructose, maltose, dextrin, levulose, tagatose, galactose, dextrose, maltodextrin, tapioca dextrin, glucose syrup, tapioca syrup, and combinations thereof. The liquid coffee beverage may comprise Suitable artificial sweeteners include saccharin, cyclamates, acetosulfame, L-aspartyl based sweeteners such as aspartame, Lu Han Guo, estevia and mixtures of these. In a preferred embodiment the liquid coffee beverage of the invention comprises between about 1% and about 20% (weight/weight) of sugars, preferably between about 2% and about 15%, more preferably between about 3% and about 10% of sugars.

The liquid coffee beverage may further comprise buffer salts such as water-soluble potassium or sodium salts to adjust the pH. Any water-soluble buffer salts can be used. In addition to the potassium or sodium salts others such as potassium or sodium carbonate, potassium or sodium bicarbonate, dipotassium or disodium hydrogen phosphate, potassium or sodium dihydrogen phosphate, tripotassium or trisodium phosphate, potassium or sodium hydroxide, potassium or sodium succinate, potassium or sodium malate, potassium or sodium citrate, and mixtures thereof. Preferably, the buffer salt is selected from the group consisting of sodium or potassium bicarbonate, sodium or potassium carbonate, sodium or potassium citrate, and disodium or dipotassium hydrogen phosphate. The pH of the finished product may typically be adjusted to between about 6 and about 8 and preferably between about 6.5 and about 7.7. The potassium or sodium salt may e.g. be present in an amount of from about 0.02% to about 0.2% by weight of the total composition.

Additional ingredients may be added to the liquid coffee beverage. Any ingredients suitable for addition to a liquid coffee beverage may be added.

### EXAMPLES

Determination of Volatile Coffee Aroma Compounds

The relative amounts of volatile coffee aroma compounds in gaseous headspace were determined by the following method:

0.6 mL of liquid coffee beverage was transferred into 2 mL silanized amber vials with crimp caps in duplicate and equilibrated at 25° C. for minimum one hour prior to analysis. Samples were analyzed by headspace-mode using a Gerstel MPS2 autosampler. A 1 cm SPME fiber coated with Carboxen, Divinylbenzene, and Polydimethylsiloxane (Supelco) was inserted into the headspace and allowed to equilibrate for 10 minutes at 25° C. The fiber was removed from the sample and placed into the injection port of a gas chromatograph (GC) (Agilent 6890) for 10 minutes at 250° C. containing a 0.75 mm ID liner (Supelco). During the first 2 minutes of desorption, the purge was off and the last eight minutes with purge on to clean the fiber. GC separation and mass spectrometric detection in SCAN mode (Agilent 5973 MSD Mass Spectrometer (29-300 m/z scan range in EI) was used for relative quantitation of the aroma compounds.

### Example 1

Two different liquid coffee beverages were produced and filled into closed containers. The composition of both samples is given in table 1.

TABLE 1
Composition of liquid beverage samples

| | % by weight |
|---|---|
| Water | 58 |
| Sugar | 5 |
| Cow's milk (0.5% fat) | 35 |
| Extract of roasted coffee beans | 1.4 |
| (amount of dry solids) | |
| Potassium citrate | 0.03 |
| Sodium bicarbonate | 0.09 |

For sample A (comparative sample) a liquid coffee beverage was produced by the following method:

Aroma was stripped from roast and ground coffee using the method disclosed in WO 01/13735, producing a gas comprising volatile coffee aroma compounds. Aroma was recovered from the steam by:

The gas was subjected to condensation at 5° C. and 1 bar to condense water and low volatile coffee aroma compounds out of the gas, producing an aqueous composition of low volatile coffee aroma compounds. To recover the high volatile aroma compounds still present in the gas leaving the condenser, the gas was compressed in a liquid ring compressor in contact with the aqueous liquid comprising the low volatile coffee aroma compounds (5° C. and 5 bar), resulting in an aqueous aroma liquid comprising both high and low volatile coffee aroma compounds.

The stripped roast and ground coffee was extracted with water using conventional technology for soluble coffee extraction. The aroma recovered from the steam was added to the coffee extract and the coffee extract was mixed with the remaining ingredients to produce a liquid coffee beverage which was filled into closed containers.

For sample B (product of the invention), a liquid coffee beverage was produced by the following method: Aroma was stripped from roast and ground coffee using the method disclosed in WO 01/13735, producing a gas comprising volatile coffee aroma compounds.

Aroma was condensed from the gas by a liquid nitrogen cooled cryogenic aroma dust collector as disclosed in U.S. Pat. No 5,222,364A at −190° C. to produce an aroma frost. The aroma frost was mixed with milk containing 3.25% milk fat (by weight) at room temperature.

The stripped roast and ground coffee was extracted with water using conventional technology for soluble coffee extraction. The milk with added coffee aroma (coffee aroma composition of the invention) was added to the coffee extract together with the remaining ingredients to produce a liquid coffee beverage with the composition given in Table 1, which was filled into closed containers.

Sensory Analysis

Sample A and B were compared with a reference sample without coffee aroma added by a sensory panel. The sensory panel found that sample B was most different from the reference sample and with more overall aroma, more coffee aroma and more sulfury aroma as well as more coffee flavor, more sulfury flavor, and less milky flavour than sample A.

Volatile aroma in the headspace of both samples were determined, the results are shown in Table 2.

TABLE 2
Relative amounts of volatile coffee aroma compounds in the headspace of
samples A and B of example 1.

| | Sample A | |
|---|---|---|
| | (comparative) | Sample B |
| High volatile coffee aroma compounds: | | |
| methanethiol | 98 | 123 |
| dimethylsulfide | 563 | 1112 |
| dimethyldisulfide | 197 | 562 |
| methylpropanal | 703 | 790 |
| 2-methylbutanal | 743 | 1036 |
| 3-methylbutanal | 757 | 1044 |
| 2-methyl-furan | 582 | 2654 |
| N-methyl-pyrrole | 1051 | 1914 |
| Medium volatile coffee aroma compounds: | | |
| acetaldehyde | 495 | 564 |
| propanal | 831 | 898 |
| hexanal | 208 | 314 |
| 2,3-butanedione | 176 | 189 |
| 2,3-pentanedione | 631 | 956 |
| furfurylpyrrole | 149 | 221 |
| Low volatile coffee aroma compounds: | | |
| 2-ethyl-5-methylpyrazine | 107 | 122 |
| 2-ethyl-6-methylpyrazine | 109 | 121 |
| trimethylpyrazine | 108 | 115 |
| 2-ethyl-3,5-dimethylpyrazine | 116 | 122 |
| 2-ethyl-3,6-dimethylpyrazine | 106 | 122 |
| 2,3-diethyl-5-methylpyrazine | 119 | 129 |
| pyridine | 100 | 98 |
| furfural | 140 | 175 |
| furfurylalcohol | 101 | 101 |
| 5-methylfurfural | 156 | 187 |
| guaiacol | 97 | 106 |
| ethylguaiacol | 102 | 113 |
| vinylguaiacol | 83 | 73 |
| acetic acid | 99 | 112 |

It is seen from Table 2 that the beverage produced with the aroma composition of the invention has a higher amount high volatile aromas in the headspace than the comparative product using a water based coffee aroma composition without milk fat.

1. A coffee aroma composition comprising milk fat and coffee aroma compounds derived from roast coffee beans in an amount of at least 1 g per gram of milk fat.

2. The coffee aroma composition of claim 1 comprising at least 0.5% of milk fat by weight.

3. The coffee aroma composition of claim 1 comprising coffee aroma compounds derived from roast coffee beans in an amount of at least 3 g per gram of milk fat.

4. The coffee aroma composition of claim 1 comprising less than 10 mg of galactomannans and arabinogalactans per g of dry matter.

5. The coffee aroma composition of claim 1 comprising milk.

6. A method of producing a coffee aroma composition, the method comprising the steps:
a) stripping coffee aroma from roast and ground coffee with steam to produce steam comprising coffee aroma;
b) recovering aroma compounds from the steam comprising coffee aroma; and
c) adding recovered aroma compounds of step b to a liquid composition comprising milk fat to produce a coffee aroma composition comprising coffee aroma and milk fat.

7. The method of claim 6 wherein the recovered aroma is added in an amount of at least 1 g of coffee aroma compounds per gram of milk fat in step c.

8. A method of producing a coffee aroma composition, the method comprising the following steps:
a) collecting aroma gas from grinding, prewetting and extraction of coffee;
b) recovering aroma compounds by a cryogenic condensation to form an aroma frost; and
c) adding recovered aroma frost of step b to a liquid composition comprising milk fat to produce a coffee aroma composition comprising coffee aroma and milk fat

9. The method of claim 6 wherein the liquid composition comprising milk fat in step c comprises milk.

10-11. (canceled)
